(19) United States
(12) Patent Application Publication
(10) Pub. No.: US 2012/0115543 A1
(43) Pub. Date: May 10, 2012

(54) HEAD MOUNTED DISPLAY APPARATUS WITH PHONE FUNCTION

(75) Inventor: HUANG-NIEN LIN, Tu-Cheng (TW)

(73) Assignee: HON HAI PRECISION INDUSTRY CO., LTD., Tu-Cheng (TW)

(21) Appl. No.: 13/097,089

(22) Filed: Apr. 29, 2011

(30) Foreign Application Priority Data
Nov. 5, 2010 (CN) 201010533423.1

(51) Int. Cl. H04M 1/00

(52) U.S. Cl. 455/556.1

(57) ABSTRACT

The present disclosure provides a head mounted display apparatus with phone function. The display apparatus includes a framework, at least one micro display mounted on the framework, a phone unit, a projecting unit, an image capturing unit, and a processing unit. The phone unit can communicate with external land phones or mobile phones to receive or dial a call. The processing unit directs the projecting unit to project a virtual keyboard onto a projection surface, directs the image capturing unit to capture images of the virtual keyboard, determines input information by comparing each captured image with the image of the initial virtual keyboard, and controls the phone unit to dial a call according to input numbers after receiving a dialing command

BACKGROUND

1. Technical Field

The present disclosure relates to head mounted display apparatus and, more particularly, to a head mounted display apparatus with phone function.

2. Description of Related Art

Conventional head mounted display apparatuses are equipped with various functions, for example, playing videos and audio or playing games, which can satisfy the normal requirements of a user, except the communications need. Therefore, a head mounted display apparatus with phone function is expected.

### BRIEF DESCRIPTION OF THE DRAWINGS

The components in the drawings are not necessarily drawn to scale, the emphasis instead being placed upon clearly illustrating the principles of the present disclose. Moreover, in the drawings, like reference numerals designate corresponding parts throughout the several views.

FIG. 1 is a schematic view of a head mounted display apparatus in accordance with an exemplary embodiment.

FIG. 2 is a schematic view showing that a virtual keyboard is projected onto a projection surface and the image of the projected virtual keyboard is captured and displayed on the head mounted display apparatus of FIG. 1.

FIG. 3 is a schematic view showing that a virtual key of the virtual keyboard of FIG. 2 is touched by an object and the image including the object is displayed on the head mounted display apparatus of FIG. 1.

### DETAILED DESCRIPTION

The disclosure is illustrated by way of example and not by way of limitation. It should be noted that references to “an” or “one” embodiment in this disclosure are not necessarily to the same embodiment, and such references mean at least one.

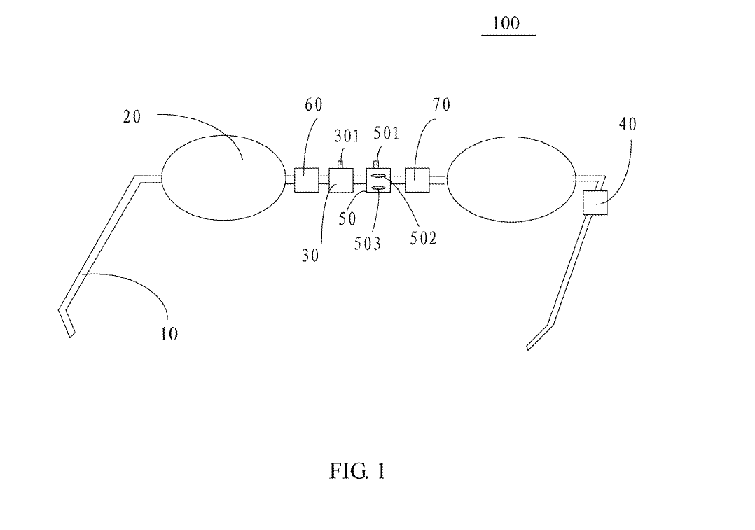

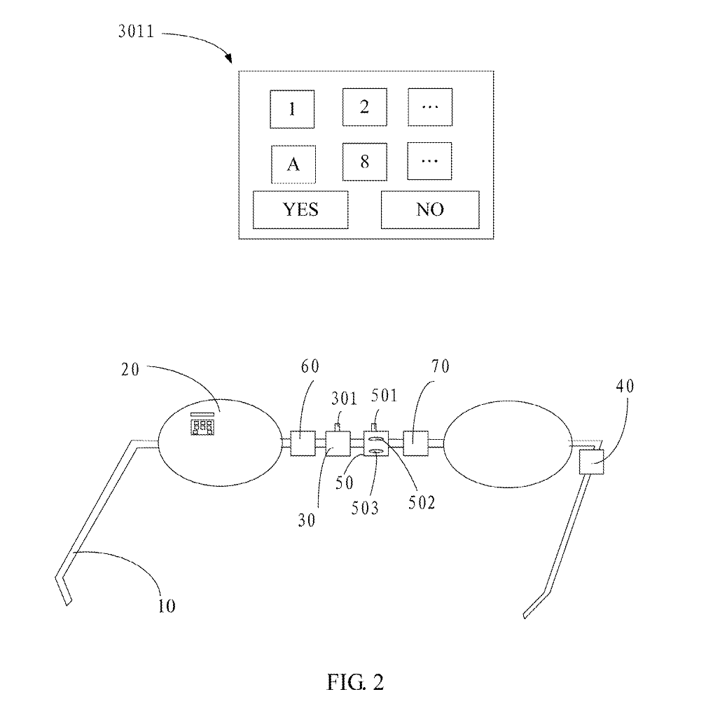

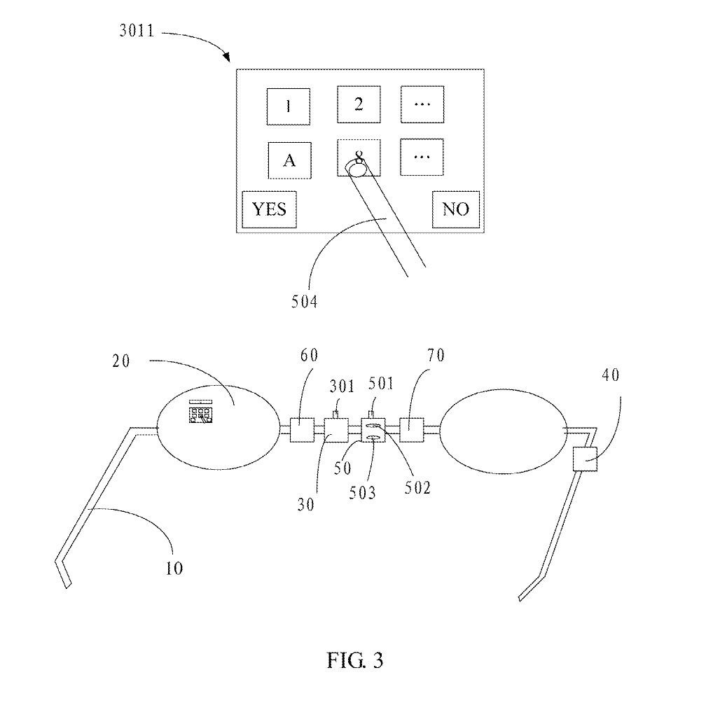

Referring to FIGS. 1-3, a head mounted display apparatus 100 capable of displaying visual information is illustrated. The display apparatus 100 has phone functions and can communicate with an external land phone or a mobile phone to receive or dial a call.

The display apparatus 100 includes a framework 10, at least one micro display 20, a processing unit 30, an interface 40, and a phone unit 50. The micro display 20, the interface 40, and the phone unit 50 are mounted on the framework 10 and are electrically connected to the processing unit 30. The display apparatus 100 can be connected to an external electronic device and can obtain audio or video data from the external electronic device through the interface 40 to be played in the display apparatus 100. In the embodiment, the display apparatus 100 includes two micro displays 20, and each micro display 20 is an LCD or an LED display. The external electronic device may be but not limited to a TV, a VCD player, a DVD player, a mobile phone, or a computer.

The phone unit 50 can communicate with external land phones or mobile phones to receive or dial a call. In this embodiment, a phone switch 501 for enabling and disabling the phone unit 50 is set on the phone unit 50. The phone unit 50 further includes an answer key 502 for answering or dialing a call and an end key 503 for hanging up a call.

The display apparatus 100 further includes a projecting unit 60 and an image capturing unit 70 which are mounted on the framework 10 and electrically connected to the processing unit 30.

A control switch 301 is arranged on the framework 10. When the control switch 301 is on, the processing unit 30 directs the projecting unit 60 to project a virtual keyboard 3011 onto a projection surface. For example, when using the display apparatus 100, the user may raise his/her one hand in front of the projecting unit 60 as a projection surface to cause the projecting unit 60 to project the virtual keyboard 3011 on the hand when the control switch 301 is on. In this embodiment, the virtual keyboard 3011 includes a plurality of alphanumeric buttons and a plurality of function buttons. The function buttons include an answer button YES for answering or dialing a call and an end button NO for hanging up a call.

When the control switch 301 is on, the image capturing unit 70 captures images of the virtual keyboard 3011 in real time.

The processing unit 30 displays each captured image on a first area of the micro display 20, such that the user wearing the display apparatus 100 can see and operate the virtual keyboard 3011 through the micro display 20. When the user operates the virtual keyboard 3011 through an object 504 such as a finger or a stylus, the captured image captured by the image capturing unit 70 includes the object 504. The processing unit 30 determines input information associated with a virtual key the user touches by comparing each captured image with the image of the initial virtual keyboard 3011, and controls the phone unit 50 to dial a call according to input numbers after receiving a dialing command. In this embodiment, the processing unit 30 compares each captured image with the image of the initial virtual keyboard 3011 to decide whether a difference exists, namely the processing unit 30 compares each captured image with the image of the initial virtual keyboard 3011 to determine whether a virtual key is currently being touched. When there is a difference between the captured images and the image of the initial virtual keyboard 3011, the processing unit 30 further determines according to the difference, which virtual key is touched by the object 504 for a predetermined interval. If the processing unit 30 determines that one virtual key is touched for a predetermined interval, that is, the processing unit 30 determines that the captured image including the object 504 touching the same virtual key is continuously captured within the predetermined interval, the processing unit 30 determines that input information associated with the touched virtual key is input. For example, when the image including the object 504 touching the virtual key labeled 8 is continuously captured within the predetermined interval, such as 2 seconds, the processing unit 30 determines that number 8 is input.

If the input information associated with the touched virtual key is a number, the processing unit 30 displays the input number on a second area of the micro display 20. If the processing unit 30 determines the input information associated with the touched virtual key is dialing a call. For example, when the answering button YES for dialing a call is touched, the processing unit 30 controls the phone unit 50 to dial a call according to the input numbers displayed on the second area of the micro display 20. In this embodiment, the answer key 502 on the phone unit 50 for dialing a call can also be used to dial a call according to the displayed numbers. For example, when the processing unit 30 determines that numbers 8, 2, 3, 5, 1 are sequentially input and the answering button YES is touched or the answer key 502 is pressed, the processing unit 30 controls the phone unit 50 to dial a call according to the numbers 82351.

In the embodiment, when the display apparatus 1 dials or receives a call, the processing unit 30 pauses applications currently performed in the display apparatus 1, such as a game, and voice input/output interfaces of the display apparatus 1 are used to receive/output voice signal.

Although the present disclosure has been specifically described on the basis of the exemplary embodiment thereof, the disclosure is not to be construed as being limited thereto. Various changes or modifications may be made to the embodiment without departing from the scope and spirit of the disclosure.

1. A head mounted display apparatus with phone function, comprising:
a framework;
at least one display mounted on the framework;
a phone unit capable of receiving or dialing a call to communicate with an external communication device;
a projecting unit;
an image capturing unit;
a processing unit to direct the projecting unit to project a virtual keyboard onto a projection surface, direct the image capturing unit to capture images of the virtual keyboard, determine input number(s) by comparing each captured image with an image of the initial virtual keyboard, display the determined input number(s) on the at least one display, and control the phone unit to dial a call according to the determined input number(s) displayed on the at least one display after receiving a dialing command.

2. The head mounted display apparatus as described in claim 1, wherein the processing unit directs the image capturing unit to capture images of the virtual keyboard in real time, compares each captured image with the image of the initial virtual keyboard to decide whether a difference exists, and determines which virtual key is touched by an object for a predetermined interval according to the difference, and when the processing unit determines that one virtual key is touched for a predetermined interval, the processing unit determines that input information associated with the touched virtual key is input.

3. The head mounted display apparatus as described in claim 2, wherein when the processing unit determines that the image comprising the object touching the same virtual key is continuously captured within the predetermined interval, the processing unit determines that the information of the touched virtual key is input.

4. The head mounted display apparatus as described in claim 1, wherein the virtual keyboard comprises a plurality of alphanumeric buttons and function buttons.

5. The head mounted display apparatus as described in claim 4, wherein the function buttons comprises an answer button YES for answering or dialing a call and an end button NO for hanging up a call.

6. The head mounted display apparatus as described in claim 1, wherein an answer key for answering or dialing a call and an end key for hanging up a call are mounted on the phone unit.

7. The head mounted display apparatus as described in claim 1 further comprising a control switch, wherein when the control switch is on, the processing unit directs the projecting unit to project the virtual keyboard onto a projection surface.

8. The head mounted display apparatus as described in claim 1 further comprising an interface mounted on the framework, wherein the display apparatus capable of being connected to an external electronic device and obtaining data from the external electronic device through the interface.

9. The head mounted display apparatus as described in claim 1, wherein the at least one display is an LCD or an LED display.

10. The head mounted display apparatus as described in claim 1, wherein when the display apparatus dials or receives a call, the processing unit pauses applications currently performed in the display apparatus, and voice input/output interfaces of the display apparatus are used to receive/output voice signal.

11. The head mounted display apparatus as described in claim 1, wherein the number of the display is two, respectively named a first display and a second display, the processing unit displays each captured image on the first display for the user to see and operate the virtual keyboard through the first display, and displays the determined input number(s) on the second display.
